(19) United States
(12) Patent Application Publication
(10) Pub. No.: US 2015/0109941 A1
(43) Pub. Date: Apr. 23, 2015

(54) MOBILE DEVICE TEST SYSTEM

(71) Applicant: Microsoft Corporation, Redmond, WA (US)

(72) Inventors: Yang Zhang, Bellevue, WA (US); Ayman Almadhoun, Bellevue, WA (US); Vikas Singh, Redmond, WA (US); Khurram Agha, Redmond, WA (US)

(73) Assignee: Microsoft Corporation, Redmond, WA (US)

(21) Appl. No.: 14/059,354

(22) Filed: Oct. 21, 2013

(51) Int. Cl. H04W 24/06; H04W 88/02; H04W 88/08

(52) U.S. Cl. CPC H04W 24/06; H04W 88/08; H04W 88/02
USPC 370/252

(57) ABSTRACT

Systems, methods, and computer media for testing mobile devices are disclosed herein. An outer signal isolation enclosure contains a group of test system components within. A plurality of inner signal isolation enclosures containing a plurality of wireless access points are contained within the outer signal isolation enclosure. An attenuator is also contained within the outer signal isolation enclosure and is connected to the plurality of wireless access points. The attenuator receives output signals from at least some of the plurality of wireless access points contained within the respective plurality of inner signal isolation enclosures and wirelessly transmits a test signal within the outer signal isolation enclosure based at least in part on the received output signals.

### FIELD

The present application relates generally to mobile device testing.

### BACKGROUND

Mobile devices have been increasingly used to access the Internet in recent years. As users continue to demand continuous Internet access from mobile devices, ensuring a smooth transition between wireless access points and/or cellular connections has gained in importance. Testing the transition between access points or between an access point and a cellular connection, however, is conventionally a cumbersome process that typically involves a technician physically moving a mobile device out of range of one access point and in range of another access point or other connection. In addition to being difficult and time consuming, in such approaches it can be difficult to limit or control noise.

### SUMMARY

Examples described herein relate to mobile device test systems. Using the systems, methods, and computer-readable media described herein, mobile devices can be tested. An outer signal isolation enclosure can contain a plurality of inner signal isolation enclosures. The inner signal isolation enclosures can contain wireless access points. An attenuator can be connected to the wireless access points to control a contribution from the respective access points to a test signal. The attenuator receives output signals from the wireless access points contained within the inner signal isolation enclosures, and based at least in part on the received output signals, the attenuator transmits a test signal within the outer signal isolation enclosure. The test signal is received by a mobile device under test, and the performance of the mobile device can be monitored in response to the test signal.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The foregoing and other objects, features, and advantages of the claimed subject matter will become more apparent from the following detailed description, which proceeds with reference to the accompanying figures.

### BRIEF DESCRIPTION OF THE DRAWINGS

FIG. 1 is a block diagram of an example mobile device test system.

FIG. 2 is a flowchart of an example method for testing a mobile device.

FIG. 3 is a flowchart of an example method for testing a mobile device that simulates a transition of the device between access points.

FIG. 4 is a block diagram of an example mobile device test system that includes a noise access point.

FIG. 5 is a block diagram of an example mobile device test system that includes a plurality of access points, a plurality of noise access points, and a variety of input ports.

FIG. 6 is a perspective view of an example mobile device test system.

FIG. 7 is a flowchart of an example method for testing a mobile device that simulates a transition of the device between an access point and a cellular source.

FIG. 8 is a diagram of an example mobile device with which some described examples can be implemented.

FIG. 9 is a diagram illustrating a generalized implementation environment in which some described examples can be implemented.

FIG. 10 is a diagram illustrating a generalized example of a suitable computing environment with which some described examples can be implemented.

### DETAILED DESCRIPTION

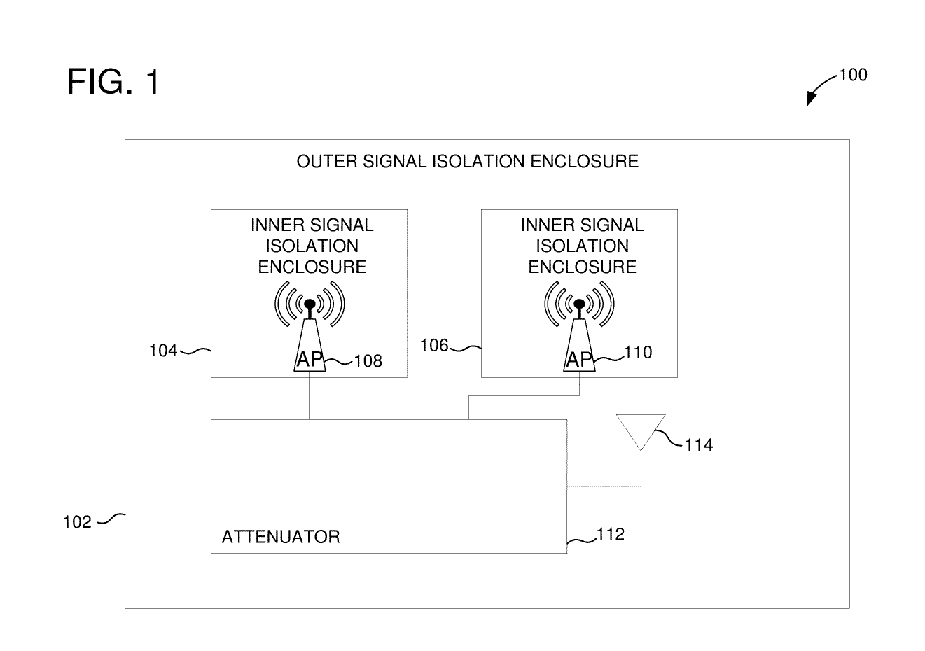

Using the systems, methods, and computer-readable media described herein, a mobile device can be tested. As discussed above, testing the performance of a mobile device during a transition between access points typically involves physically transporting the mobile device out of range of one access point and in range of another access point. The mobile device test systems described herein allow a mobile device to be tested while remaining stationary in a test enclosure. The test systems described herein also allow multiple tests to be conducted using a single test system. Examples are described in detail below with reference to FIGS. 1-10.

FIG. 1 illustrates an example mobile device test system 100. Mobile device test system 100 includes an outer signal isolation enclosure 102. Outer signal isolation enclosure 102 isolates the volume contained within from radio frequency (RF) signals of at least a desired frequency range. For example, outer signal isolation enclosure 102 can be designed to isolate the contained volume from external signals at Wi-Fi frequencies (e.g., 2.4 GHz, 3.6 GHz, 4.9 GHz, and/or 5 GHz) and cellular frequencies (e.g., 700 MHz, 800 MHz, 850 MHz, 1.7 GHz, 1.9 GHz, and/or 2.1 GHz). Outer signal isolation enclosure 102 can also isolate the contained volume at other frequencies. As used herein “isolation” refers to attenuating a signal (e.g., a signal external to the outer signal isolation enclosure 102) such that the signal reaching the contained volume has a magnitude (e.g. a sufficiently low magnitude) or other characteristic that does not interfere with mobile device testing in the contained volume. Isolation does not require complete exclusion of a signal from the contained volume.

Outer signal isolation enclosure 102 can be a “Faraday cage,” which is an enclosure typically having a solid conductor layer or a layer of interconnected conductive elements such as a metal mesh. The conductive nature of the Faraday cage shields the volume enclosed by the Faraday cage from electromagnetic radiation originating outside of the cage. Outer signal isolation enclosure 102 can also be another type of enclosure that may not be strictly considered to be a Faraday cage. In some examples, outer signal isolation enclosure 102 can be an “RF test enclosure” made by Ramsey Electronics.

Inner signal isolation enclosures 104 and 106 are contained within outer signal isolation enclosure 102. Inner signal isolation enclosures 104 and 106 can also be Faraday cages and can be designed and configured similarly to outer signal isolation enclosure 102. Wireless access points (APs) 108 and 110 are contained within inner signal isolation enclosures 104 and 106, respectively. Throughout this document, inner signal isolation enclosures are illustrated as containing a single AP. In some examples, multiple APs are contained within some inner signal isolation enclosures; such an arrangement can simulate an AP whose signal has noise. As used herein, “wireless access point” refers to a device that allows wireless devices, such as mobile devices, to connect to a wired connection or network. APs can receive wireless signals transmitted from and transmit wireless signals to the mobile devices. APs can communicate, for example, using IEEE 802.11 standards (as used in Wi-Fi® communications).

An attenuator 112 is connected to APs 108 and 110. Attenuator 112 receives output signals from APs 108 and 110 and wirelessly transmits a test signal within outer signal isolation enclosure 102 via antenna 114. Although shown as two separate components in FIG. 1, antenna 114 may be internal to attenuator 112. The transmitted test signal is based at least in part on the received output signals from APs 108 and 110. Attenuator 112 can be, for example, an attenuator made by Aeroflex Microelectronic Solutions. In some examples, a different component that can receive output signals from APs and generate a test signal is used in place of attenuator 112. Contributions to the test signal from APs 108 and 110 can be independently variable.

The test signal transmitted by antenna 114 can be received by one or more mobile devices under test (not shown) that are contained within outer signal isolation enclosure 102, and the performance of the device can be monitored as one or more tests are performed using the test signal. Outer signal isolation enclosure 102 thus functions to isolate the other components of mobile device test system 100 from signals originating outside of outer signal isolation enclosure 102, while inner signal isolation enclosures 104 and 106 ensure that output signals generated by APs 108 and 110, which are used by attenuator 112 to generate the test signal, are isolated from a device under test. With this arrangement, the test signal produced by attenuator 112 and transmitted by antenna 114 can be received by the device under test without interference, and one or more tests can be performed on the device.

By locating the access points (e.g., APs 108 and 110) within inner signal isolation enclosures (e.g., 104 and 106) and using an attenuator outside the inner signal isolation enclosures to transmit a test signal that includes contributions from the APs, the wireless signals from the APs can be more accurately controlled (e.g., can be varied precisely from zero signal strength to maximum signal strength).

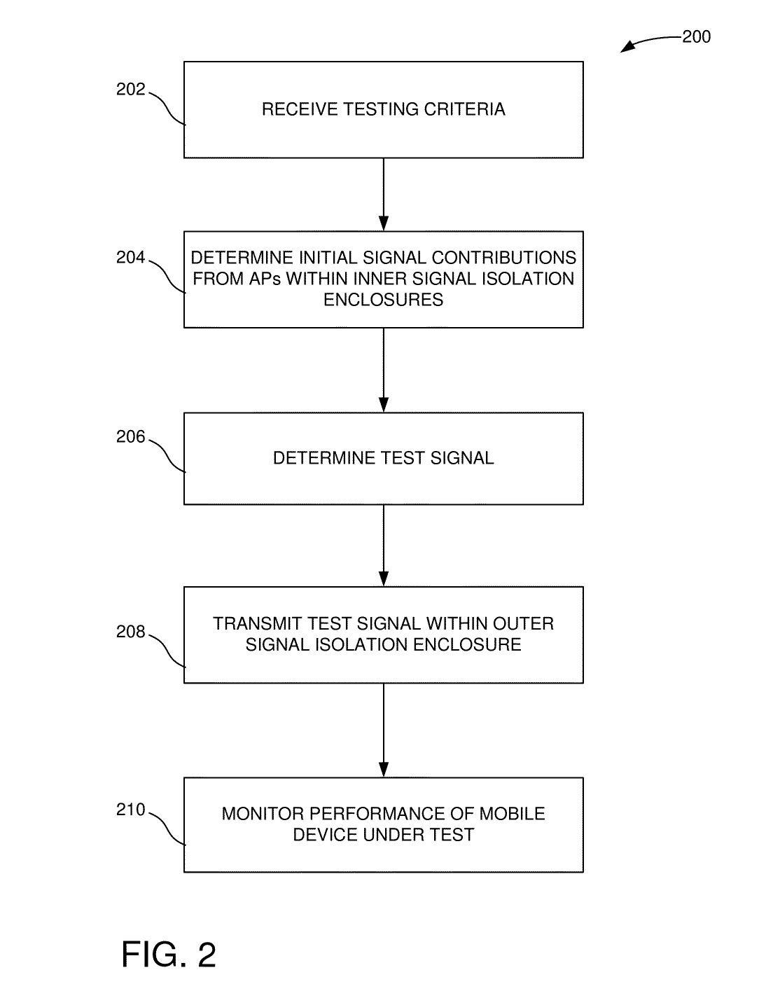

FIG. 2 illustrates an example method 200 of testing a mobile device. In process block 202, testing criteria are received. Testing criteria can include an indication of a predetermined test to run; a transmission pattern for a test; signal strength contributions for different APs; test data packets or an indication of test data; a test frequency; test duration; authentication types (e.g., Wi-Fi Protected Access® (WPA), etc.) to use for different APs; or a variety of other parameters or test information. In process block 204, an initial signal contribution from respective APs in a plurality of APs is determined based on the criteria. The respective APs are contained within a respective plurality of inner signal isolation enclosures, such as inner signal isolation enclosures 104 and 106 of FIG. 1. The inner signal isolation enclosures are contained within an outer signal isolation enclosure, such as outer signal isolation enclosure 102 of FIG. 1.

In process block 206, a test signal is determined based at least in part on the signal contributions from the respective APs contained within the respective plurality of inner signal isolation enclosures. The test signal is transmitted within the outer signal isolation enclosure in process block 208. The contributions to the test signal from multiple APs replicate actual use situations in which a mobile device receives signals from multiple APs. For example, while being operated by a user in a non-testing scenario, a mobile device might receive a stronger signal from a nearby AP and a weaker signal from a distant AP. The test signal can thus be determined to include a greater contribution from a first AP to represent the nearby AP and a lesser contribution from a second AP to represent the distant AP. The performance of the mobile device under test in response to the test signal is monitored in process block 210. Performance can be measured, for example, in terms of dropped packets, whether a current download/upload continues, delays in a current download/upload, which AP the device connects to, dropped calls, or other metric.

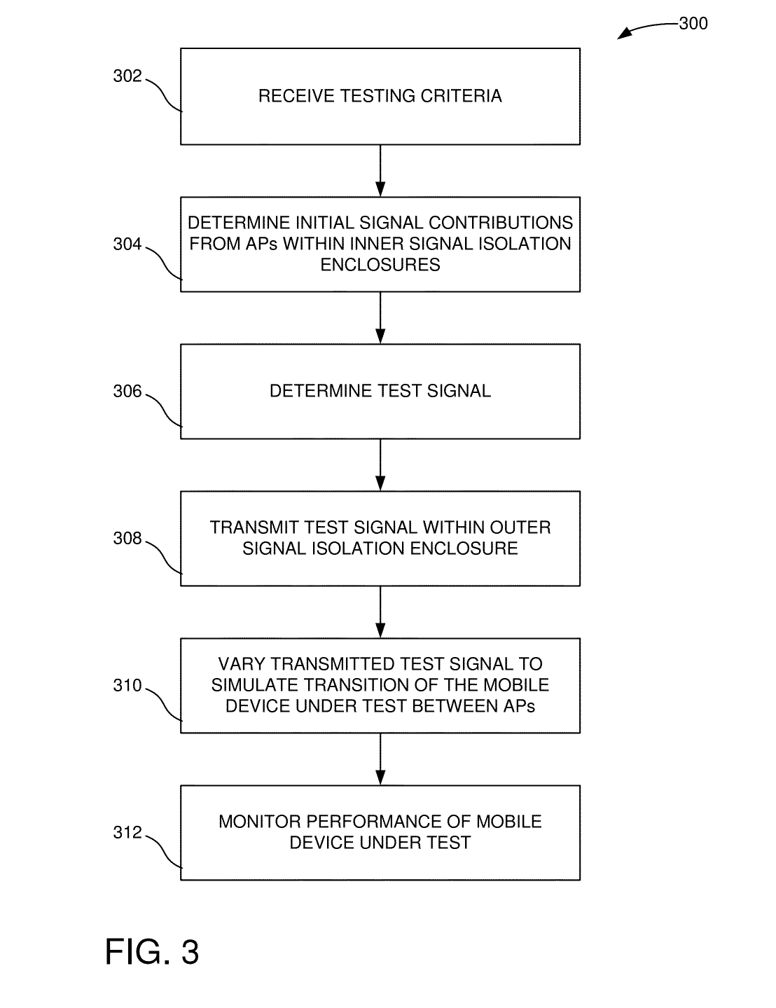

FIG. 3 illustrates an example method 300 of testing a mobile device. In process block 302, testing criteria are received. In process block 304, an initial signal contribution from respective APs in a plurality of APs is determined based on the criteria. The respective APs are contained within a respective plurality of inner signal isolation enclosures, such as inner signal isolation enclosures 104 and 106 of FIG. 1. The inner signal isolation enclosures are contained within an outer signal isolation enclosure, such as outer signal isolation enclosure 102 of FIG. 1. In process block 306, a test signal is determined based at least in part on the signal contributions from the respective APs contained within the respective plurality of inner signal isolation enclosures. The test signal is transmitted within the outer signal isolation enclosure in process block 308.

In process block 310, the transmitted test signal is varied to simulate a transition of the mobile device under test between APs located external to the outer signal isolation enclosure. For example, the test signal can be varied to simulate the real-world situation where a user is walking with a mobile device from one AP to another AP (e.g., from one end of an office building where a first AP is located to the other end of the office building where a second AP is located). In some examples, varying the test signal comprises reducing a contribution to the test signal from a first of the plurality of APs and increasing a contribution to the test signal from a second of the plurality of APs. Varying the test signal in this way simulates moving the wireless device under test away from a first AP external to the outer signal isolation enclosure and toward a second AP external to the outer signal isolation enclosure. The performance of the mobile device under test in response to the test signal is monitored in process block 312.

For example, testing can be performed by starting with the contribution from the first AP at a lower level (e.g., 10%) and contribution from the second AP at a higher level (e.g., 80%). Testing can then continue with the contribution from the first AP raised over time to a higher level (e.g., 80%) while the contribution from the second AP is correspondingly lowered over the same time to a lower level (e.g., 10%). Operation of the device under test can then be monitored. For example, the device under test can be monitored to determine whether it successfully switches from being connected to the second AP to being connected to the first AP. Similarly, the device under test can be tested to determine whether streaming data continues uninterrupted during transition of connectivity between the access points.

The contribution from each AP can be independently varied. In some examples, a contribution from a first AP can be held constant while a contribution from a second AP is varied. This can simulate a mobile AP or hot spot moving along with a mobile device. For example, a user operating a mobile device could be walking with another person whose mobile device is acting as a hot spot. In this scenario, the signal from the mobile hot spot will remain relatively constant, but other APs might increase or decrease in signal strength.

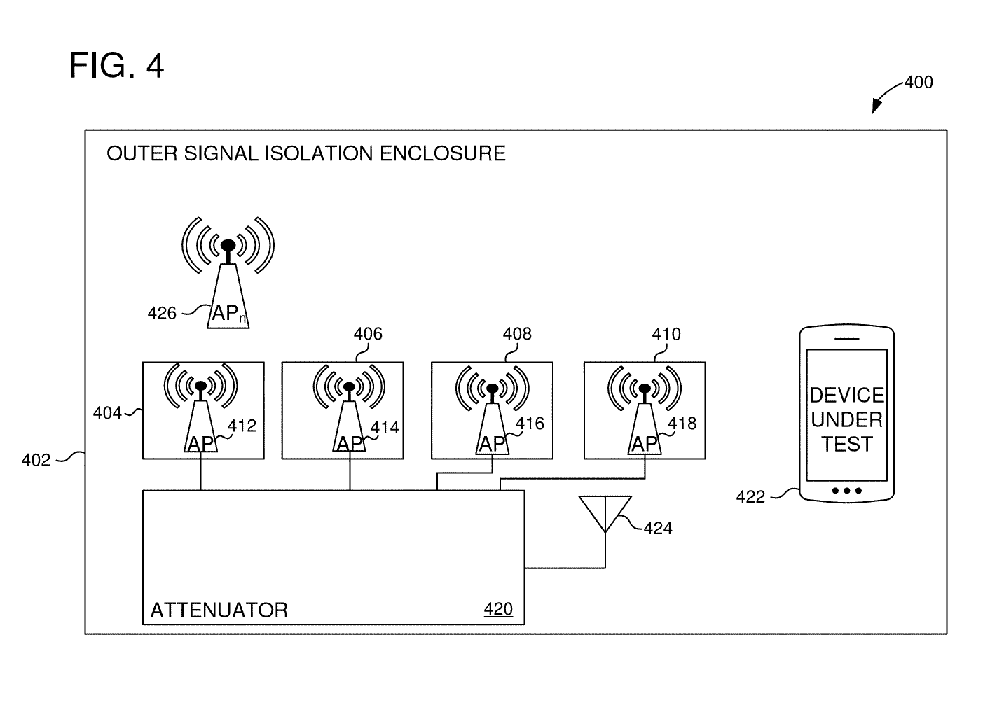

FIG. 4 illustrates a mobile device test system 400. Mobile device test system 400 includes outer signal isolation enclosure 402 and inner signal isolation enclosures 404, 406, 408, and 410 containing APs 412, 414, 416, and 418, respectively. An attenuator 420 is connected to APs 412, 414, 416, and 418. Attenuator 420 is configured to wirelessly provide a test signal to a mobile device 422 under test via antenna 424. The test signal can be, for example, a Wi-Fi test signal. The test signal is based at least in part on output signals received from at least some of APs 412, 414, 416, and 418.

Mobile device test system 400 can vary the test signal transmitted by attenuator 420 in order to perform one or more tests. For example, reducing a contribution to the test signal from one of APs 412, 414, 416, and 418 and increasing a contribution to the test signal from a second one of APs 412, 414, 416, and 418 can simulate transitioning mobile device 422 under test from a connection with one AP external to outer signal isolation enclosure 402 to a connection with another AP external to outer signal isolation enclosure 402.

Noise AP 426 is also contained within outer signal isolation enclosure 402. Unlike APs 412, 414, 416, and 418, noise AP 426 is not contained within an inner signal isolation enclosure. Noise AP 426 transmits a noise signal to mobile device 422 under test. In some examples, a plurality of noise APs is contained within outer signal isolation enclosure 402. The noise signal transmitted by noise AP 426 simulates RF signals present in an actual use environment that are considered noise. The noise signal can include multiple sub-signals of various frequencies and magnitudes.

Outer signal isolation enclosure 402; inner signal isolation enclosures 404, 406, 408, and 410; APs 412, 414, 416, and 418; attenuator 420; and antenna 424 can be similar to the corresponding components of system 100 in FIG. 1.

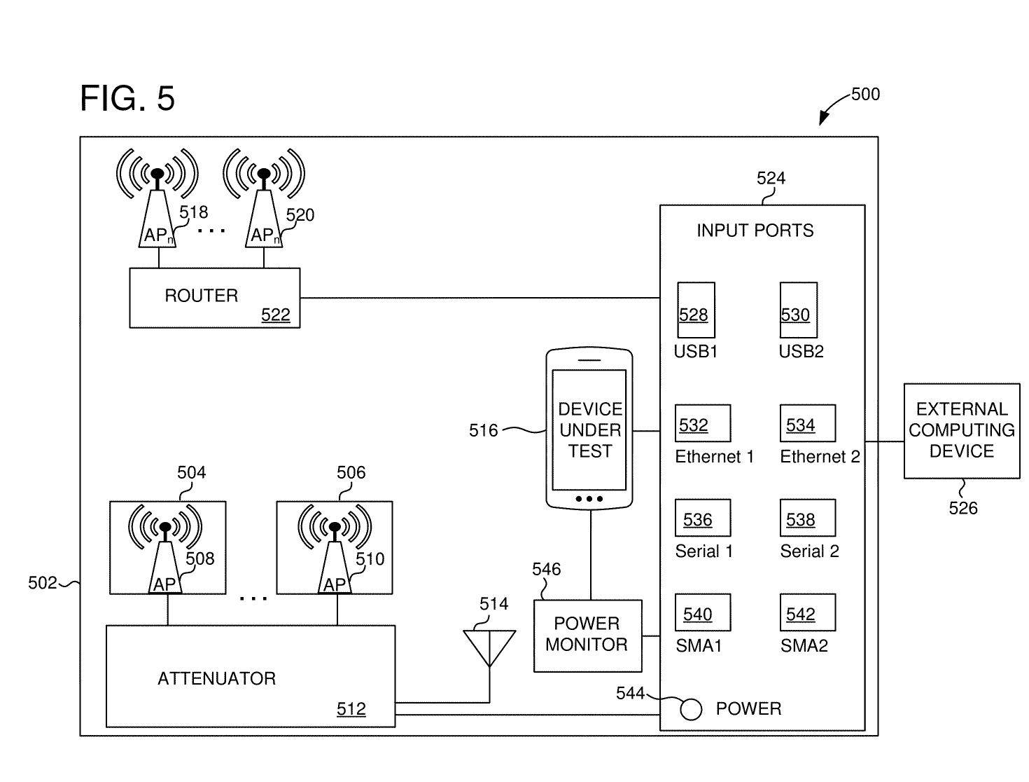

FIG. 5 illustrates a mobile device test system 500. Mobile device test system 500 includes outer signal isolation enclosure 502 and inner signal isolation enclosures 504 and 506 containing APs 508 and 510, respectively. The ellipsis between inner signal isolation enclosure 504 and inner signal isolation enclosure 506 indicates that additional inner signal isolation enclosures containing APs are possible. For example, system 500 can contain at least four inner signal isolation enclosures and corresponding APs. An attenuator 512 is connected to APs 508 and 510. Attenuator 512 is configured to wirelessly provide a test signal to a mobile device 516 under test via antenna 514. The test signal can be, for example, a Wi-Fi test signal. The test signal is based at least in part on output signals received from at least some of APs 508 and 510.

System 500 also includes noise APs 518 and 520. As with inner signal isolation enclosures 504 and 506, the ellipsis between noise AP 518 and noise AP 520 indicates that additional noise APs are possible. Router 522 provides noise signals to noise APs 518 and 520 for transmission. System 500 further comprises a plurality of input ports 524. Input ports 524 connect an external computing device 526 to router 522, attenuator 512, and mobile device 516 under test. External computing device 526 is not contained within outer signal isolation enclosure 502. External computing device 526 can be, for example, a server computer or laptop computer; can run test software; and can communicate testing criteria and other information to router 522, attenuator 512, and mobile device 516 under test via input ports 524.

In some embodiments, mobile device 516 under test has a testing “app” or application or other software that enables a test sequence to be selected or specified by mobile device 516 under test. Mobile device 516 under test can communicate testing instructions to external computing device 526 via input ports 524, and external computing device 526 can communicate with router 522 and attenuator 512. Testing software, whether through a testing app on mobile device 516 under test or through external computing device 526 can be a web-based service (e.g., implemented in HTTP), allowing mobile device testing to be controlled through any device having Internet access. In some examples, at least one of the ports of input ports 524 communicates a test control signal to attenuator 512 that at least in part determines the test signal transmitted by attenuator 512. The test control signal can include testing criteria.

Input ports 524 are accessible from outside outer signal isolation enclosure 502. In this way, external computing device 526 can be plugged in to input ports 524 to communicate with the components of system 500 that are contained within outer signal isolation enclosure 502. Input ports 524 can include, for example, universal serial bus (USB) ports 528 and 530; Ethernet ports 532 and 534; serial ports 536 and 538; SubMiniature version A (SMA) ports 540 and 542; and a power port 544. Additional ports and connector types can be included as needed. Output ports 524 can also be connected to a power monitor 546 that monitors the performance of mobile device 516 under test. For example, power monitor 546 can monitor an amount of battery capacity that is used during various portions of testing. In some examples, monitoring software is installed on mobile device 516 under test and/or external computing device 526 that monitors performance metrics such as dropped packets; whether a current download/upload continues; delays in a current download/upload; dropped calls; or other metric.

Outer signal isolation enclosure 502; inner signal isolation enclosures 504 and 506; APs 508 and 510; attenuator 512; antenna 514; and noise APs 518 and 520 can be similar to the corresponding components of system 100 in FIG. 1 and system 400 in FIG. 4.

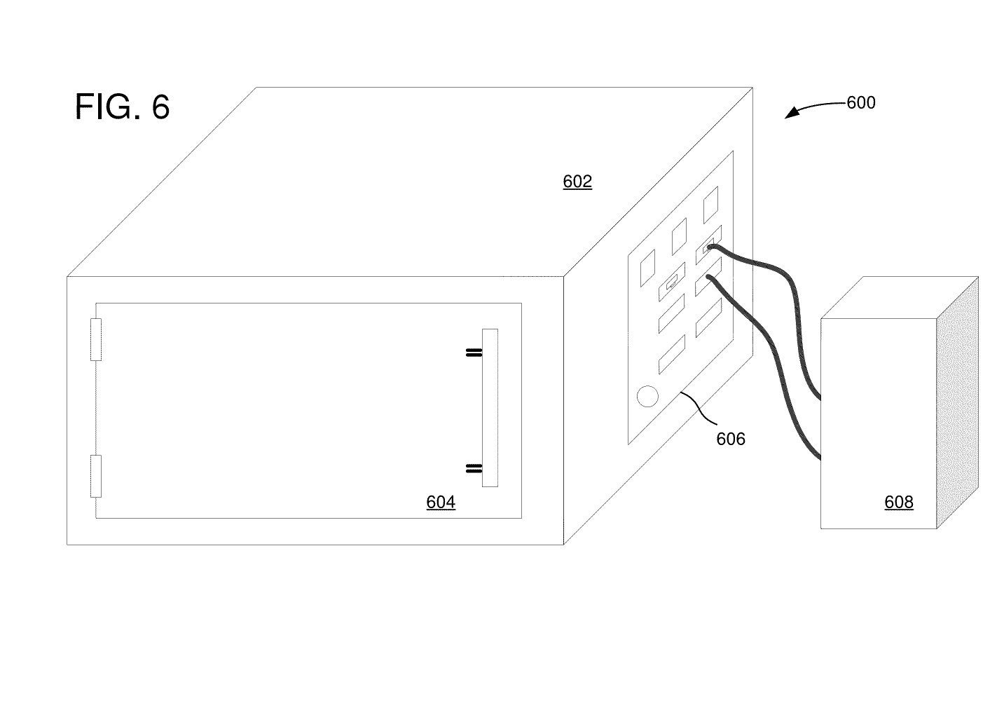

FIG. 6 illustrates a perspective view of a mobile device test system 600. Outer signal isolation enclosure 602 is shown in FIG. 6 in a “cabinet” form having a door 604 that opens for access to the components contained within (such as inner signal isolation enclosures, APs, attenuator, noise AP(s), router, mobile device under test, etc.). Input ports 606 allow external computing device 608 to communicate with the components contained within outer signal isolation enclosure 602.

Outer signal isolation enclosure 602 can be portable. For example, the dimensions of outer signal isolation enclosure 602 can be approximately 3 feet×2 feet×3 feet, although a variety of dimensions are possible. System 600 can easily be transported among locations and can be easily stored in a single room or office.

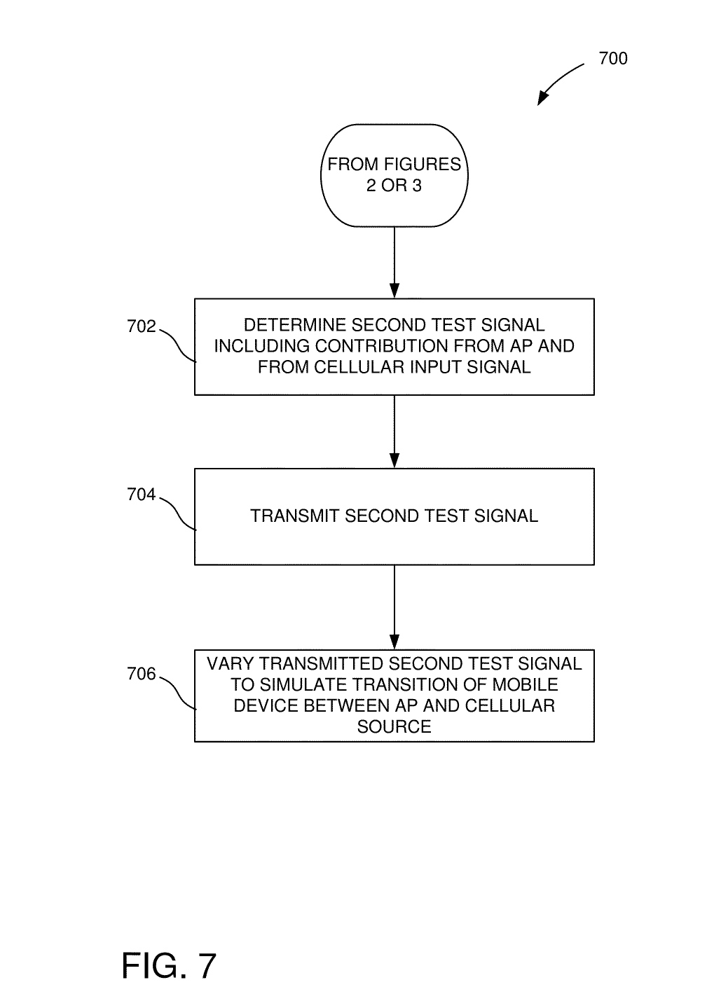

FIG. 7 illustrates a method 700 of testing a mobile device. Method 700 can be performed after method 200 of FIG. 2 or method 300 of FIG. 3. Alternatively, method 700 can be performed independently. In process block 702, a second test signal is determined that includes a signal contribution from at least one of the APs and a signal contribution from a cellular input signal. The test signal can be transmitted, for example, by an attenuator such as the attenuators discussed with respect to FIGS. 1, 4, and 5. The cellular input signal can be provided, for example, through the input ports discussed with respect to FIGS. 5 and 6. In process block 704, the second test signal is transmitted. The transmitted second test signal is varied in process block 706. Varying the second test signal simulates a transition of a mobile device under test between an AP located external to the outer signal isolation enclosure and a cellular signal source located external to the outer signal isolation enclosure.

In some embodiments, a separate cellular test signal is used that is based at least in part on the cellular input signal. The cellular test signal can be transmitted by an attenuator, router, or other device. The transition of the mobile device under test between an AP located external to the outer signal isolation enclosure and a cellular signal source located external to the outer signal isolation enclosure can be simulated by varying the second test signal, which can be a Wi-Fi test signal, and varying a signal strength of the cellular test signal. Such a scenario tests the “hand off” between cellular source and AP.

For example, testing can be performed by starting with the second test signal, which is based on contributions from one or more APs, at a higher level (e.g., 80%) and contribution from the cellular test signal at a lower level (e.g., 30%). Testing can then continue with the second test signal decreased over time to a lower level (e.g., 10%) while the cellular test signal is correspondingly increased over the same time to a higher level (e.g., 90%). Operation of the device under test can then be monitored. For example, the device under test can be monitored to determine whether it successfully switches from being connected to an AP (via the second test signal) to being connected to the cellular source. Similarly, the device under test can be tested to determine whether streaming data continues uninterrupted during transition of connectivity from AP to cellular source.

In some examples, the strength of the cellular test signal remains constant while the strength of the second test signal is reduced (e.g., reduced below a threshold). Such a scenario simulates a user connected to an AP (e.g., at a coffee shop) downloading or streaming content and then walking out of range of the AP (e.g., leaving the coffee shop) and continuing the downloading/streaming using a cellular source.

### Example Mobile Device

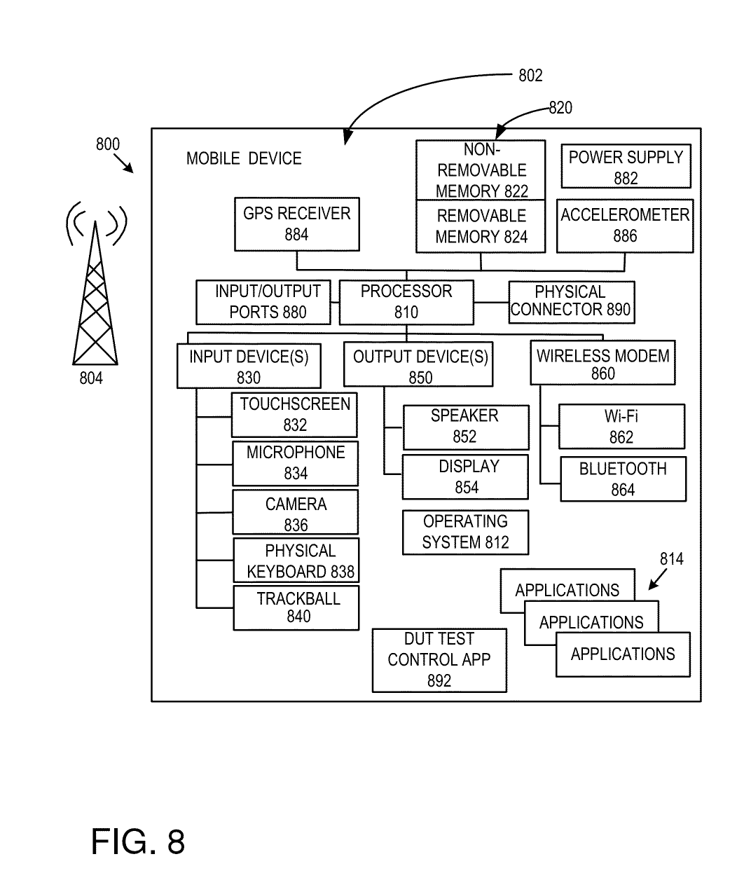

FIG. 8 is a system diagram depicting an exemplary mobile device 800 including a variety of optional hardware and software components, shown generally at 802. Any components 802 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 804, such as a cellular or satellite network.

The illustrated mobile device 800 can include a controller or processor 810 (e.g., signal processor, microprocessor, ASIC, or other control and processing logic circuitry) for performing such tasks as signal coding, data processing, input/output processing, power control, and/or other functions. An operating system 812 can control the allocation and usage of the components 802 and support for one or more application programs 814. The application programs can include common mobile computing applications (e.g., email applications, calendars, contact managers, web browsers, messaging applications), or any other computing application. Operating system 812 can also support device under test (DUT) control “app” or application 892, DUT control app 892 provides an interface for selecting or specifying one or more tests to run on a mobile device, as discussed above with respect to FIG. 5.

The illustrated mobile device 800 can include memory 820. Memory 820 can include non-removable memory 822 and/or removable memory 824. The non-removable memory 822 can include RAM, ROM, flash memory, a hard disk, or other well-known memory storage technologies. The removable memory 824 can include flash memory or a Subscriber Identity Module (SIM) card, which is well known in GSM communication systems, or other well-known memory storage technologies, such as “smart cards.” The memory 820 can be used for storing data and/or code for running the operating system 812 and the applications 814. Example data can include web pages, text, images, sound files, video data, or other data sets to be sent to and/or received from one or more network servers or other devices via one or more wired or wireless networks. The memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 800 can support one or more input devices 830, such as a touchscreen 832, microphone 834, camera 836, physical keyboard 838 and/or trackball 840 and one or more output devices 850, such as a speaker 852 and a display 854. Other possible output devices (not shown) can include piezoelectric or other haptic output devices. Some devices can serve more than one input/output function. For example, touchscreen 832 and display 854 can be combined in a single input/output device. The input devices 830 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can comprise speech-recognition software as part of a voice user interface that allows a user to operate the device 800 via voice commands. Further, the device 800 can comprise input devices and software that allows for user interaction via a user's spatial gestures, such as detecting and interpreting gestures to provide input to a gaming application.

A wireless modem 860 can be coupled to an antenna (not shown) and can support two-way communications between the processor 810 and external devices, as is well understood in the art. The modem 860 is shown generically and can include a cellular modem for communicating with the mobile communication network 804 and/or other radio-based modems (e.g., Bluetooth 864 or Wi-Fi 862). The wireless modem 860 is typically configured for communication with one or more cellular networks, such as a GSM network for data and voice communications within a single cellular network, between cellular networks, or between the mobile device and a public switched telephone network (PSTN).

The mobile device can further include at least one input/output port 880, a power supply 882, a satellite navigation system receiver 884, such as a Global Positioning System (GPS) receiver, an accelerometer 886, and/or a physical connector 890, which can be a USB port, IEEE 1394 (FireWire) port, and/or RS-232 port. The illustrated components 802 are not required or all-inclusive, as any components can be deleted and other components can be added.

### Example Implementation Environment

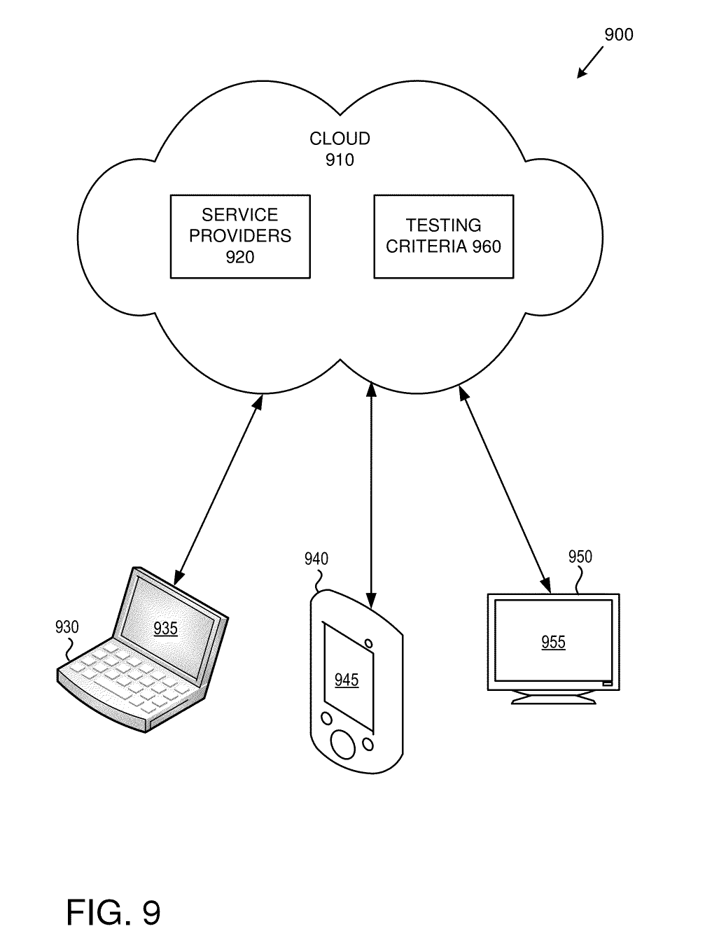

FIG. 9 illustrates a generalized example of a suitable implementation environment 900 in which described embodiments, techniques, and technologies may be implemented.

In example environment 900, various types of services (e.g., computing services) are provided by a cloud 910. For example, the cloud 910 can comprise a collection of computing devices, which may be located centrally or distributed, that provide cloud-based services to various types of users and devices connected via a network such as the Internet. The implementation environment 900 can be used in different ways to accomplish computing tasks. For example, some tasks (e.g., processing user input and presenting a user interface) can be performed on local computing devices (e.g., connected devices 930, 940, 950) while other tasks (e.g., storage of data to be used in subsequent processing) can be performed in the cloud 210.

In example environment 900, the cloud 910 provides services for connected devices 930, 940, 950 with a variety of screen capabilities. Connected device 930 represents a device with a computer screen 935 (e.g., a mid-size screen). For example, connected device 930 could be a personal computer such as desktop computer, laptop, notebook, netbook, or the like. Connected device 940 represents a device with a mobile device screen 945 (e.g., a small size screen). For example, connected device 940 could be a mobile phone, smart phone, personal digital assistant, tablet computer, or the like. Connected device 950 represents a device with a large screen 955. For example, connected device 950 could be a television screen (e.g., a smart television) or another device connected to a television (e.g., a set-top box or gaming console) or the like. One or more of the connected devices 930, 940, 950 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 900. For example, the cloud 910 can provide services for one or more computers (e.g., server computers) without displays.

Services can be provided by the cloud 910 through service providers 920, or through other providers of online services (not depicted). For example, cloud services can be customized to the screen size, display capability, and/or touchscreen capability of a particular connected device (e.g., connected devices 930, 940, 950).

In example environment 900, the cloud 910 provides the technologies and solutions described herein to the various connected devices 930, 940, 950 using, at least in part, the service providers 920. For example, the service providers 920 can provide a centralized solution for various cloud-based services. The service providers 920 can manage service subscriptions for users and/or devices (e.g., for the connected devices 930, 940, 950 and/or their respective users). Cloud 910 can store various testing criteria 960 for testing mobile devices. A computing device such as connected devices 935, 940, and/or 950 can retrieve mobile device testing criteria 960 from cloud 910 to perform one or more tests of a mobile device.

### Example Computing Environment

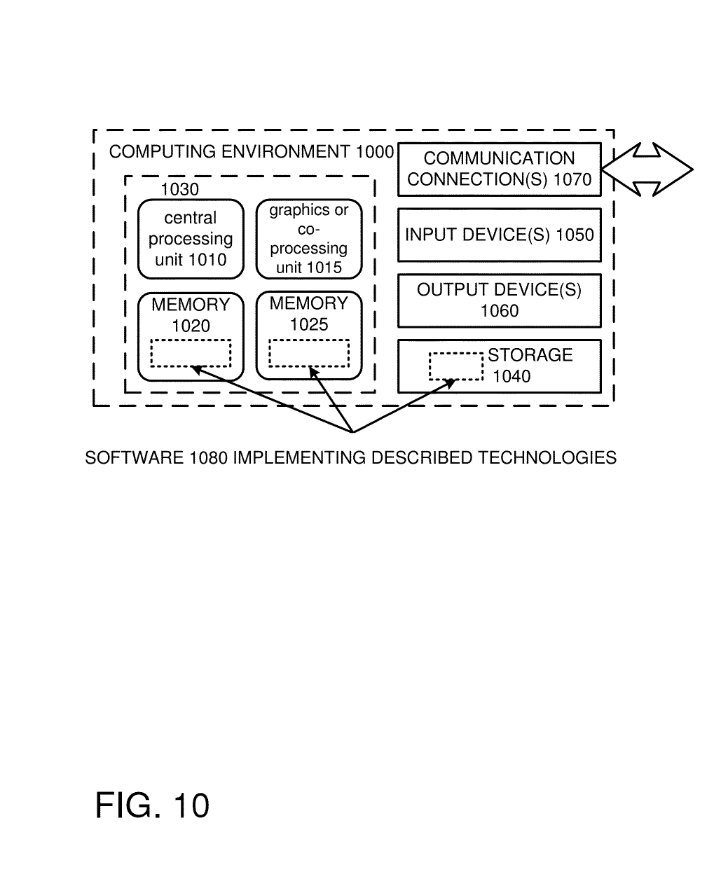

FIG. 10 depicts a generalized example of a suitable computing environment 1000 in which the described innovations may be implemented. The computing environment 1000 is not intended to suggest any limitation as to scope of use or functionality, as the innovations may be implemented in diverse general-purpose or special-purpose computing systems. For example, the computing environment 1000 can be any of a variety of computing devices (e.g., desktop computer, laptop computer, server computer, tablet computer, media player, gaming system, mobile device, etc.)

With reference to FIG. 10, the computing environment 1000 includes one or more processing units 1010, 1015 and memory 1020, 1025. In FIG. 10, this basic configuration 1030 is included within a dashed line. The processing units 1010, 1015 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 may be volatile memory (e.g., registers, cache, RAM), non-volatile memory (e.g., ROM, EEPROM, flash memory, etc.), or some combination of the two, accessible by the processing unit(s). The memory 1020, 1025 stores software 1080 implementing one or more innovations described herein, in the form of computer-executable instructions suitable for execution by the processing unit(s). For example, memory 1020 and 1025 and software 1080 can store computer-executable instructions for performing one or more tests of a mobile device as described herein.

A computing system may have additional features. For example, the computing environment 1000 includes storage 1040, one or more input devices 1050, one or more output devices 1060, and one or more communication connections 1070. An interconnection mechanism (not shown) such as a bus, controller, or network interconnects the components of the computing environment 1000. Typically, operating system software (not shown) provides an operating environment for other software executing in the computing environment 1000, and coordinates activities of the components of the computing environment 1000.

The tangible storage 1040 may be removable or non-removable, and includes magnetic disks, magnetic tapes or cassettes, CD-ROMs, DVDs, or any other medium which can be used to store information and which can be accessed within the computing environment 1000. The storage 1040 stores instructions for the software 1080 implementing one or more innovations described herein.

The input device(s) 1050 may be a touch input device such as a keyboard, mouse, pen, or trackball, a voice input device, a scanning device, or another device that provides input to the computing environment 1000. For video encoding, the input device(s) 1050 may be a camera, video card, TV tuner card, or similar device that accepts video input in analog or digital form, or a CD-ROM or CD-RW that reads video samples into the computing environment 1000. The output device(s) 1060 may be a display, printer, speaker, CD-writer, or another device that provides output from the computing environment 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A mobile device test system comprising:
an outer signal isolation enclosure having contained within:
a plurality of inner signal isolation enclosures;
a plurality of wireless access points contained within the respective plurality of inner signal isolation enclosures; and
an attenuator connected to the plurality of wireless access points, wherein the attenuator:
receives output signals from at least some of the plurality of wireless access points contained within the respective plurality of inner signal isolation enclosures; and
wirelessly transmits a test signal within the outer signal isolation enclosure based at least in part on the received output signals.

2. The system of claim 1, further comprising a plurality of input ports connected to the attenuator and accessible from outside the outer signal isolation enclosure, wherein at least one of the plurality of input ports communicates a test control signal to the attenuator that at least in part determines the test signal transmitted by the attenuator.

3. The system of claim 2, wherein a cellular signal is provided to the attenuator by one of the plurality of input ports.

4. The system of claim 1, wherein the output signals received from the plurality of wireless access points are Wi-Fi signals.

5. The system of claim 1, wherein the system is portable.

6. The system of claim 1, wherein the system comprises at least four inner signal isolation enclosures each having at least one wireless access point contained within.

7. The system of claim 1, wherein the attenuator is connected to at least one of a mobile device under test located inside the outer signal isolation enclosure or a computing device located outside of the outer signal isolation enclosure.

8. The system of claim 1, further comprising:
at least one noise access point contained within the outer signal isolation enclosure, wherein the at least one noise access point is not contained within an inner signal isolation enclosure, and wherein the at least one noise access point transmits a noise signal to a mobile device under test.

9. The system of claim 1, further comprising:
a mobile device undergoing testing within the outer signal isolation enclosure, wherein the system simulates the mobile device moving between wireless access points by varying the test signal transmitted by the attenuator.

10. The system of claim 9, wherein varying the test signal comprises reducing a contribution to the test signal from a first of the plurality of wireless access points and increasing a contribution to the test signal from a second of the plurality of wireless access points to simulate moving the mobile device away from a wireless access point external to the outer signal isolation enclosure and toward another wireless access point external to the outer signal isolation enclosure.

11. The system of claim 9, wherein contributions to the test signal from the plurality of wireless access points are independently variable.

12. A method of testing a mobile device, the method comprising:
receiving criteria for testing a mobile device under test;
based on the criteria, determining an initial signal contribution from respective wireless access points in a plurality of wireless access points, wherein the respective access points are contained within a respective plurality of inner signal isolation enclosures, and wherein the inner signal isolation enclosures are contained within an outer signal isolation enclosure;
determining a test signal based at least in part on the signal contributions from the respective wireless access points contained within the respective plurality of inner signal isolation enclosures;
transmitting the test signal within the outer signal isolation enclosure; and
monitoring the performance of the mobile device under test in response to the test signal.

13. The method of claim 12, further comprising:
varying the transmitted test signal to simulate a transition of the mobile device under test between wireless access points located external to the outer signal isolation enclosure.

14. The method of claim 13, wherein the varying comprises reducing a contribution to the test signal from a first of the plurality of wireless access points and increasing a contribution to the test signal from a second of the plurality of wireless access points, wherein the varying simulates moving the mobile device under test away from a first wireless access point external to the outer signal isolation enclosure and toward a second wireless access point external to the outer signal isolation enclosure.

15. The system of claim 12, further comprising:
determining a second test signal that includes a signal contribution from at least one of the wireless access points and a signal contribution from a cellular input signal;
transmitting the second test signal; and
varying the transmitted second test signal, wherein varying the second test signal simulates a transition of the mobile device under test between a wireless access point located external to the outer signal isolation enclosure and a cellular signal source located external to the outer signal isolation enclosure.

16. The system of claim 12, further comprising:
transmitting a noise signal from a noise source contained within the outer signal isolation enclosure.

17. A mobile device test system comprising:
a portable signal isolation enclosure having contained within:
a plurality of inner signal isolation enclosures;
a plurality of wireless access points contained within the respective plurality of inner signal isolation enclosures;
an attenuator connected to the plurality of wireless access points, wherein the attenuator is configured to wirelessly provide a Wi-Fi test signal to a mobile device under test, and wherein the Wi-Fi test signal is based at least in part on output signals received from at least some of the wireless access points contained within the respective plurality of inner signal isolation enclosures; and
at least one noise access point contained within the portable signal isolation enclosure, wherein the at least one noise access point transmits a noise signal to the mobile device under test.

18. The system of claim 17, wherein the system comprises:
at least four inner signal isolation enclosures each having at least one wireless access point contained within; and
at least two noise access points.

19. The system of claim 17, wherein the system varies the Wi-Fi test signal transmitted by the attenuator by reducing a contribution to the Wi-Fi test signal from a first of the plurality of wireless access points and increasing a contribution to the Wi-Fi test signal from a second of the plurality of wireless access points to simulate transitioning the mobile device from a connection with one wireless access point external to the portable signal isolation enclosure to a connection with another wireless access point external to the portable signal isolation enclosure.

20. The system of claim 17, wherein the attenuator is connected to a cellular input signal, and wherein the system is configured to simulate a transition of the mobile device under test between a wireless access point located external to the outer signal isolation enclosure and a cellular signal source located external to the outer signal isolation enclosure by varying the Wi-Fi test signal and varying a signal strength of a cellular test signal that is based at least in part on the cellular input signal.
